(19) United States
(12) Patent Application Publication
(10) Pub. No.: US 2025/0003512 A1
(43) Pub. Date: Jan. 2, 2025

(54) Removable Drain Valve

(71) Applicant: Illinois Tool Works Inc., Glenview, IL (US)

(72) Inventor: Mark O. Lepper, Oak Park, IL (US)

(21) Appl. No.: 18/753,574

(22) Filed: Jun. 25, 2024

Related U.S. Application Data
(60) Provisional application No. 63/524,268, filed on Jun. 30, 2023.

(51) Int. Cl. F16K 24/04; F16K 17/02; F16K 27/02; H01M 10/613; H01M 10/625; H01M 10/6568

(52) U.S. Cl. CPC F16K 24/04; F16K 17/02; F16K 27/0236; H01M 10/613; H01M 10/625; H01M 10/6568; H01M 2220/20

(57) ABSTRACT

Described is a valve assembly to control fluid flow through a component opening in a component. The valve assembly includes a valve body, an annular seal, and a flapper. The valve body has a passageway through which fluid can flow. A rigid support mesh is located within the passageway. The rigid support mesh includes one or more walls configured to divide the passageway into two or more sub-regions, and a first plurality of ribs arranged transverse to a second plurality of ribs and configured to form a grid of mesh openings within each quarter-circle region. The flapper is coupled to the rigid support mesh and configured to permit one-way fluid flow through the passageway. The valve assembly is configured to removably couple with the component via the component opening.

### CROSS-REFERENCE

The present application claims priority to U.S. Provisional Patent Application No. 63/524,268, filed Jun. 30, 2023, and entitled “Removable Drain Valve” which is hereby incorporated by reference in its entirety.

### BACKGROUND

The electric drive components in electric vehicles (EVs), such as the engine, battery, and power electronics, pose special challenges to the fasteners and functional components like valves. As a result, the fasteners, and functional components for the technical aspects of the electric vehicle powertrain are important. The best way to respond to the challenges that arise when developing these components, such as electrical insulation, compact design, light weight, and resistance to corrosion, is provided by innovative fastener solutions. These also add value through ergonomic or automated assembly.

EV battery systems often employ one or more drainage valves. Generally speaking, the drainage valves are used to manage the release of fluids or gases within the battery pack. Primary functions of drainage valves include, for example, thermal management, safety and venting, maintenance, and servicing.

EV batteries generate heat during operation and charging. To mitigate overheating, battery systems often include cooling mechanisms, which may use liquid coolant. A drainage valve allows for the controlled release or replacement of this coolant during maintenance or in case of leakage. In the event of thermal runaway or internal damage, batteries can release gases or fluids. Drainage valve ensure that these substances can be vented safely, preventing pressure build-up within the battery pack that could lead to explosions or fires.

Valve assemblies are important components in fluid control systems, providing the necessary regulation of fluid flow. Conventional valve assemblies often suffer from structural weaknesses that may compromise their performance and reliability. There is a need for an improved valve assembly that offers enhanced structural integrity and ensures reliable one-way fluid flow. Indeed, drainage valves drain any unwanted water penetration immediately. Therefore, despite advancements to date, a need exists for an improved drainage valve, such as a removable drainage valve.

### SUMMARY

The present disclosure relates generally to a valve assembly to drain fluid from a volume, such as automotive battery housings and assemblies, substantially as illustrated by and described in connection with at least one of the figures, as set forth more completely in the claims. More specifically, the present disclosure relates generally to a drainage valve assembly for us in, inter alia, EVs.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a perspective assembly view of an example drainage valve system having a valve assembly in accordance with aspects of this disclosure.

FIG. 1b illustrates a perspective assembled view of the example drainage valve system with the valve assembly in an unlocked position.

FIG. 1c illustrates a perspective assembled view of the example drainage valve system with the valve assembly in a locked position.

FIG. 1d illustrates a side elevation assembly view of the example drainage valve system.

FIG. 1e illustrates a side elevation assembled view of the example drainage valve system.

FIGS. 2a and 2b illustrate, respectively, topside and underside perspective assembled views of the example valve assembly.

FIGS. 2c and 2d illustrate, respectively, top and bottom plan views of the example valve assembly.

FIGS. 2e through 2h illustrate, respectively, first, second, third, and fourth side elevation views of the example valve assembly.

FIGS. 2i and 2j illustrate, respectively, topside and underside perspective assembly views of the example valve assembly.

FIG. 3a illustrates a perspective cross-sectional view of the example valve assembly taken along cutline A-A (FIG. 2c).

FIG. 3b illustrates a side elevation cross-sectional view of the example valve assembly taken along cutline A-A (FIG. 2c).

FIG. 3c illustrates a top plan view of Detail A (FIG. 2c) of the example valve assembly.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a valve assembly to drain fluid from a volume, such as automotive battery housings and assemblies, substantially as illustrated by and described in connection with at least one of the figures, as set forth more completely in the claims. More specifically, the present disclosure relates generally to a removeable one-way drainage valve assembly for us in, inter alia, EVs.

The features and functions of the disclosed valve assembly offer several distinct advantages. First, it offers a poke yoke feature to ensure that the valve assembly can only be assembled in one of two orientations: zero degrees or 180 degrees, simplifying installation and reducing errors. In some examples, the valve structure incorporates four offset walls that, in addition to providing support to the valve assembly, serve as gripping points for easier manual adjustment. The walls are strategically designed to facilitate fluid drainage to the valve edges, enhancing efficiency.

Additionally, the interface between the valve body and Seal includes one or more torque resistance features that secure the seal during both installation and removal processes, ensuring reliability over time. The benefits of these innovations include intuitive alignment with the panel, ergonomic installation, and clear visual, tactile, and/or, audible feedback during assembly. Additionally, the valve assembly enables high-flow fluid drainage in one direction while effectively sealing against fluid flow in the other direction, ensuring optimal performance. Its sub-flush design further protects the valve from potential interference with packages positioned above the panel surface, maintaining functionality and longevity.

In one example, a valve assembly configured to control fluid flow through a component opening in a component comprises: a valve body having a passageway through which fluid can flow; a rigid support mesh located within the passageway, the rigid support mesh including one or more walls configured to divide the passageway into two or more sub-regions, and a first plurality of ribs arranged transverse to a second plurality of ribs and configured to form a grid of mesh openings within each quarter-circle region; and a flapper coupled to the rigid support mesh and configured to permit one-way fluid flow through the passageway, wherein the valve assembly is configured to removably couple with the component via the component opening.

In another example, a valve assembly configured to control fluid flow through a component opening in a component comprises: a valve body having a passageway through which fluid can flow; a rigid support mesh located within the passageway, the rigid support mesh including one or more walls configured to divide the passageway into two or more sub-regions, and a first plurality of ribs arranged transverse to a second plurality of ribs and configured to form a grid of mesh openings within each quarter-circle region; and a flapper coupled to the rigid support mesh and configured to permit one-way fluid flow through the passageway, wherein the flapper is configured to open in response to fluid pressure in one direction and to close to prevent backflow, and wherein the valve assembly is configured to removably couple with the component via the component opening.

In yet another example, a valve assembly configured to control fluid flow through a component opening in a component comprises: a valve body having a passageway through which fluid can flow, wherein the valve body comprises a plurality of component-locking tabs, each of the plurality of component-locking tabs is configured to engage the component opening via a receiver in one of an unlocked or a locked position; a rigid support mesh located within the passageway, the rigid support mesh including one or more walls configured to divide the passageway into two or more sub-regions, and a first plurality of ribs arranged transverse to a second plurality of ribs and configured to form a grid of mesh openings within each quarter-circle region; a flapper coupled to the rigid support mesh and configured to permit one-way fluid flow through the passageway, wherein the flapper is configured to open in response to fluid pressure in one direction and to close to prevent backflow, and wherein the valve assembly is configured to removably couple with the component via the component opening; and an annular seal configured to form a seal between the valve body and the component opening.

In some examples, the valve body further comprises a third plurality of ribs arranged to further divide each mesh opening into a smaller grid having a plurality of flow openings.

In some examples, a cross-sectional area of each of the third plurality of ribs is smaller than a cross-sectional area of each of the first and second plurality of ribs.

In some examples, the flapper is configured to open in response to fluid pressure in one direction and to close to prevent backflow.

In some examples, the rigid support mesh provides structural support to the flapper to maintain its position and functionality.

In some examples, the valve body further comprises an annular seal configured to form a seal between the valve body and the opening.

In some examples, the valve body comprises a complex topography and the annular seal is coupled to the valve body at the complex topography.

In some examples, the valve body and the rigid support mesh are unitary components.

In some examples, the valve body is a rigid component.

In some examples, the flapper is a flexible component.

In some examples, the flapper is coupled to the rigid support mesh via a pin receiver.

In some examples, the flapper comprises a conical body having a rim at its outer perimeter and an attachment pin at its center.

In some examples, the attachment pin is aligned with the central axis.

In some examples, the valve body comprises a plurality of component-locking tabs, each of the plurality of component-locking tabs is configured to engage the component opening via a receiver in one of an unlocked or a locked position.

In some examples, the valve body comprises a plurality of component-attachment features, each of the plurality of component-attachment features is configured to engage the component on a side opposite the receiver.

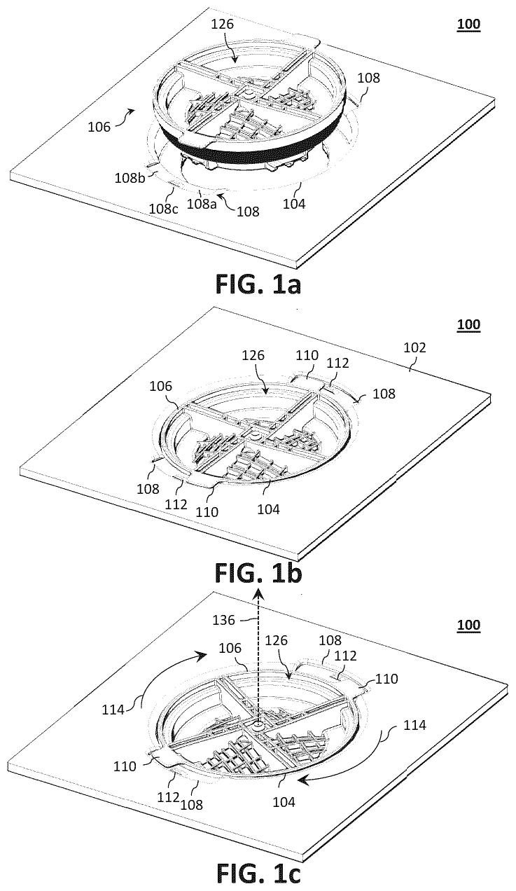

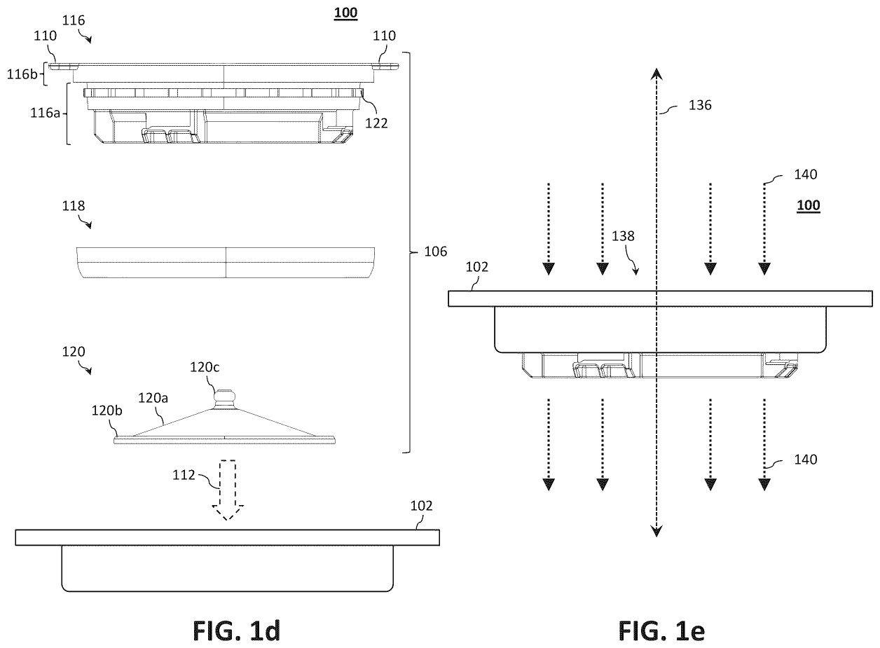

FIG. 1a illustrates a perspective assembly view of an example drainage valve system 100 having a valve assembly 106 coupled to a component 102 in accordance with aspects of this disclosure. FIG. 1b shows a perspective assembled view of the example drainage valve system 100 with the valve assembly 106 in an unlocked position, while FIG. 1c shows it in a locked position. FIG. 1d provides a side elevation assembly view of the example drainage valve system 100, and FIG. 1e offers a side elevation assembled view.

The valve assembly 106 of the drainage valve system 100 is configured to provide one-way fluid flow through a component opening in the component 102. In the various examples, the component opening is illustrated as a recessed opening 104, but other shapes and configurations are contemplated. The valve assembly 106, therefore, operates as a check valve to enable fluid to, for example, exit a volume via the recessed opening 104, but prohibits fluid from entering the volume via the recessed opening 104. In the illustrated example, once installed, the valve assembly 106 is flush with the component 102.

In the illustrated example, as best illustrated in FIG. 1c, the component 102 includes, defines, or otherwise provides the recessed opening 104, illustrated as a recessed window sized to receive at least a portion of the valve body 116. The recessed opening 104 is configured to receive and securely engage the valve assembly 106. Specifically, the recessed opening 104 includes one or more receivers 108 (e.g., slots, recessed grooves, or other such recessed regions), each designed to accommodate an attachment feature of the valve assembly 106.

Depending on the application, the component 102 may be fabricated from materials such as metal (or metal alloy), synthetic or semi-synthetic polymers (e.g., acrylonitrile butadiene styrene (ABS), polyvinyl chloride (PVC), etc.), composite materials (e.g., fiberglass), or a combination thereof. In one example, the component 102 is an automotive panel. The component 102 may be a component of a vehicle, such as a battery housing, battery assembly, doors, pillars (e.g., A-pillar, B-pillar, C-pillar), dashboard components (e.g., cross member, bracket, frame), center consoles, fenders, sills, sheet metal framework, or similar parts.

The illustrated valve assembly 106 comprises a valve body 116, an annular seal 118, and a flapper 120. The annular seal 118 can be over-molded or otherwise affixed to the valve body 116 in a fixed position, while the flapper 120 is configured to move or flex relative to the valve body 116. To facilitate attachment with the component 102, the valve assembly 106 comprises one or more attachment features. In the illustrated example, the one or more attachment features includes one or more component-locking tabs 110 and one or more component-attachment features 202, such as a bayonet-type attachment feature. Specifically, the illustrated valve assembly 106 includes two component-locking tabs 110 and four component-attachment features 202. The two component-locking tabs 110 are illustrated as being distributed 180 degrees about the central axis 136, while the four component-attachment features 202 are illustrated as being distributed 90 degrees about the central axis 136.

The component-locking tabs 110, which can be integrally molded tabs or machined flanges, are designed to engage and secure within recessed openings 104 positioned on a first side of the component 102. In the illustrated example, tach component-locking tab 110 is designed to be positioned in a respective receiver 108 selectively in either an unlocked position (first position) or a locked position (second position). For example, the attachment feature 110 is initially positioned in a respective receiver 108 at a first location 108a (unlocked position) and then rotated to a second location 108b (locked position).

The first location 108a and second location 108b can be divided or otherwise separated by a detent 108c (e.g., a bump or protrusion), thus providing tactile feedback and helping maintain the attachment feature 110 in its respective first or second location 108a, 108b. In some examples, the valve assembly 106 engages and secures within the recessed opening 104 via a quarter-turn rotational motion (e.g., 90-degree twist-and-turn motion) or other fractional rotational motion (e.g., 10- to 45-degree twist-and-turn motion).

The component-attachment features 202 are configured to pass or otherwise extend at least through the recessed opening 104 to engage and secure with the component 102 on its second side (i.e., a side opposed the first side). Effectively, when assembled, a portion of the component 102 at or near the recessed opening 104 is sandwiched between the component-locking tabs 110 and the component-attachment features 202.

To install the valve assembly 106, referring to FIG. 1a, the valve assembly 106 is first aligned with the recessed opening 104. Then, as shown in FIG. 1b, insert the valve assembly 106 into the recessed opening 104 as indicated by arrow 112, positioning it at the first location 108a in an unlocked position. Next, as depicted in FIG. 1c, the valve assembly 106 is rotated about its central axis 136 as indicated by arrows 114. This rotation causes the attachment features 110 to move past, over, or around the detent 108c and into the second location 108b within the recessed opening 104, locking the valve assembly 106 securely in place.

The valve body 116 includes a first body portion 116a (illustrated as a lower portion) and a second body portion 116b (illustrated as an upper portion). The valve body 116 defines a passageway 138 that permits fluid 140 to flow therethrough. In the illustrated example, the first body portion 116a includes or defines the component-attachment features 202, while the second body portion 116b includes or defines the component-locking tabs 110.

The valve body 116 can be fabricated from one or more rigid materials, such as synthetic or semi-synthetic polymers (e.g., acrylonitrile butadiene styrene (ABS), polyvinyl chloride (PVC), etc.), composite materials (e.g., fiberglass), or a combination thereof using plastic injection techniques, additive manufacturing, or other methods. In some examples, the valve body 116 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, or other additive manufacturing/3D printing processes). In other examples, the valve body 116 can be fabricated from a metal (or a metal alloy).

The flapper 120 is configured to fluidically seal the passageway 138 within the drain body 116. In some examples, the flapper 120 is configured as a flexible component that can be biased toward or away from the passageway 138 to control flow therethrough.

The drain body 116 can further incorporate or define a rigid support mesh 126. The rigid support mesh 126 can be positioned within the passageway 138 of the drain body 116 and configured to provide structural support for the flapper 120 when it is installed. The rigid support mesh 126 can be integrally formed with the drain body 116 (as illustrated) or formed separately and coupled thereto. As illustrated, the rigid support mesh 126 defines the central frame 132 that includes a pin receiver 134. As illustrated, the central frame 132 and the pin receiver 134 can be positioned at a center of the rigid support mesh 126 to facilitate securement (e.g., a secured attachment) of the flapper 120. For example, the central frame 132 and the pin receiver 134 can be concentric about the central axis 136. While illustrated as having a central frame 132, the central frame 132 can be omitted and the pin receiver 134 can be formed in a different portion of the valve body 116 and/or the rigid support mesh 126.

The flapper 120 comprises a conical body 120a, engineered for optimal fluid dynamics and sealing efficiency. As illustrated, the conical body 120a can complement the surface contours of the rigid support mesh 126. A rim 120b can be positioned along the perimeter of the base (wide portion) of the conical body 120a. The rim 120b is configured to make or maintain a continuous, firm contact with the perimeter of the passageway 138, thereby ensuring a reliable fluid-tight seal. The attachment mechanism of the flapper 120 includes an attachment pin 120c, which is crafted to engage securely with the pin receiver 134 in the rigid support mesh 126. The conical body 120a, the rim 120b, and the attachment pin 120c can be integrally formed with the flapper 120 (as illustrated) or formed separately and coupled thereto. Accordingly, the flapper 120 can be fabricated as a single component from a single material or from multiple components (and, optionally, of multiple, different materials) to form the flapper 120.

The design of the attachment pin includes a bulbous head, which reduces the risk of the attachment pin 120c pulling out of the pin receiver 134 under operational stresses (e.g., fluidic pressure). This bulbous head enhances the retention strength, ensuring the flapper 120 remains firmly in place, thus maintaining the integrity of the seal within the drain body 116. This configuration ensures that the flapper 120 performs its sealing function reliably, supported by the rigid support mesh 126, even under varying fluid pressures and flow conditions. In practice, to form the connection, the attachment pin 120c of the flapper 120 is pushed through the pin receiver 134 of the valve body 116 (via the pin receiver 134 of the central frame 132). The attachment pin 120c (e.g., the bulbous head) is thus malleable to enable it to compress and/or deform to enable it to pass through the pin receiver 134.

The annular seal 118 is positioned around the perimeter of the valve body 116. The annular seal 118 is designed to ensure a fluid tight seal between the valve body 116 and the component 102 (e.g., at, in, or adjacent to the recessed opening 104), thus mitigating fluid leakage and maintaining system integrity. The tailored fit between the recessed opening 104 and the valve assembly 106 ensures reliable engagement, preventing unintentional dislodgment or leakage.

The annular seal 118 and/or flapper 120 may be fabricated from a foam material, thermoplastic, rubber materials, etc. Example thermoplastics include polyethylene (PE), polyvinyl chloride (PVC), among others. The annular seal 118 can be over-molded and/or formed through a two-shot (2 k) process with the valve body 116. Alternatively, the annular seal 118 and/or the flapper 120 can be formed through a die-cutting process and positioned on the valve body 116. For instance, the annular seal 118 can be formed separately and then overlaid, adhered, or otherwise positioned on the valve body, while the flapper 120 can be formed separately and attached mechanically (e.g., via the attachment pin 120c).

Removal of the valve assembly 106 follows the reverse of the above-described installation process; by rotating the valve assembly 106 in the opposite direction (e.g., opposite that of arrows 114), the attachment features 110 disengage from the receivers 108, allowing for easy extraction. This twist- and-turn mechanism facilitates secure and reliable installation and allows for efficient and straightforward removal for routine maintenance, inspection, or replacement. Applications include automotive hosing, automotive fluid reservoirs, industrial machinery components, and HVAC systems, where quick and reliable sealing, venting, and draining solutions are necessary or useful.

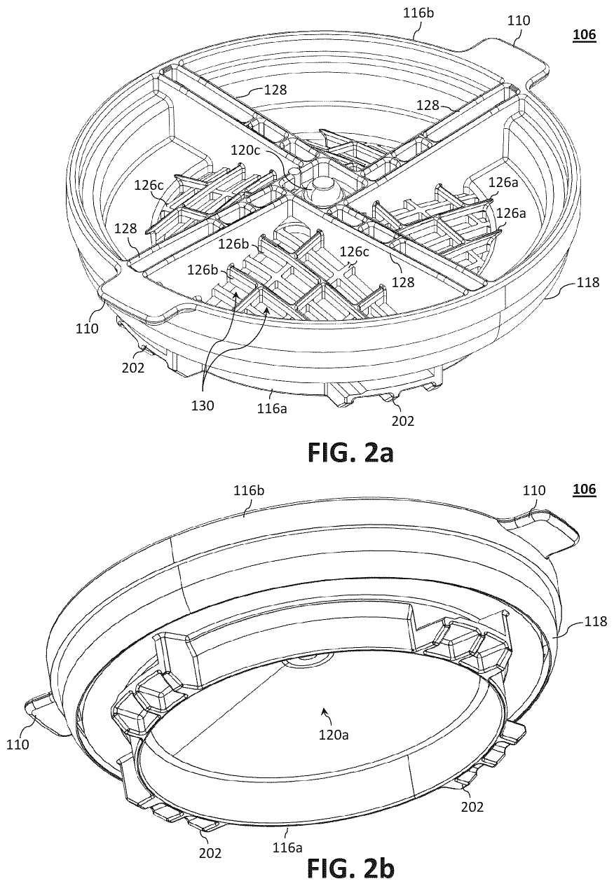

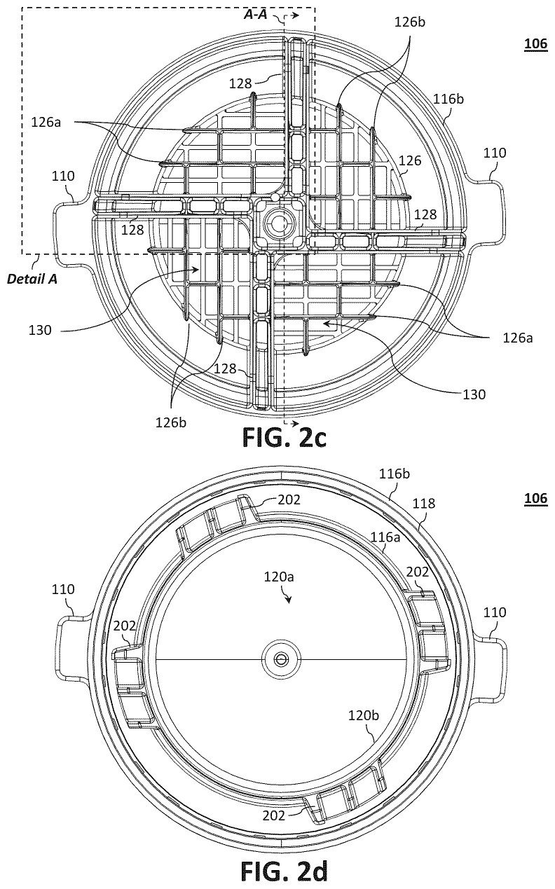

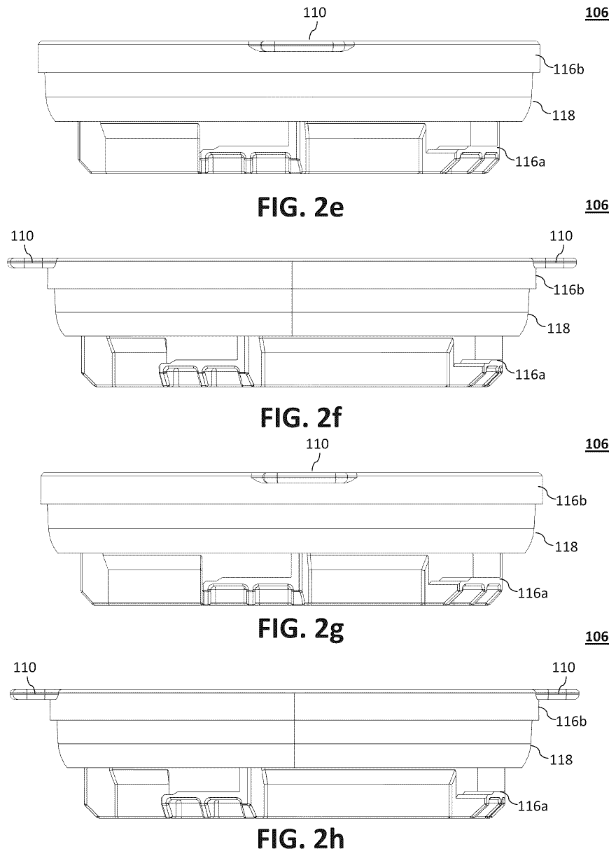

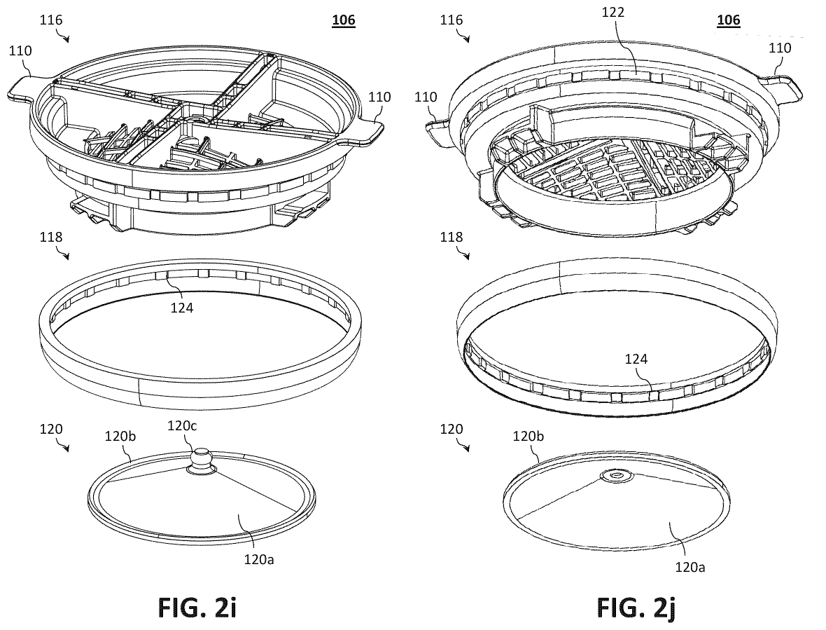

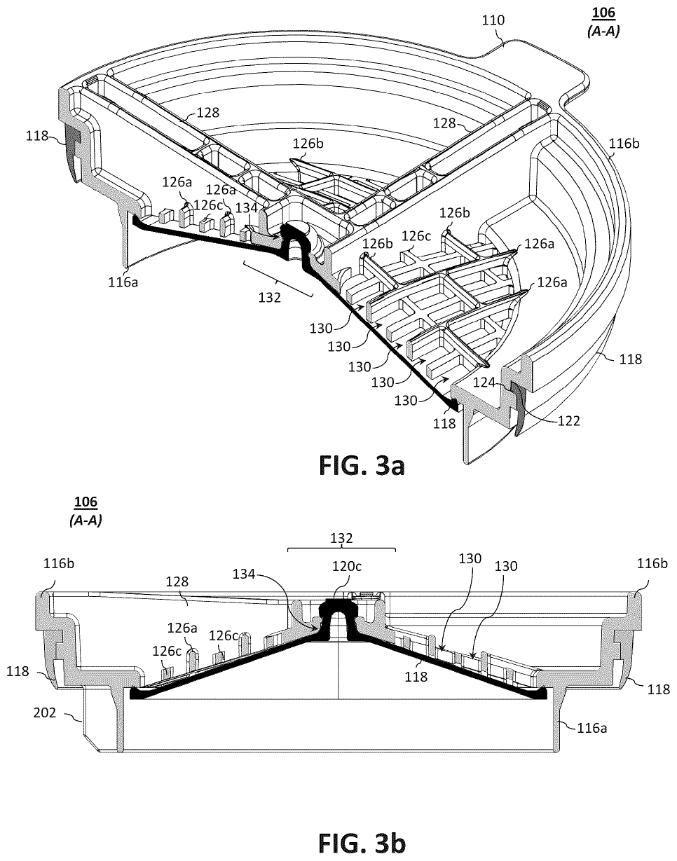

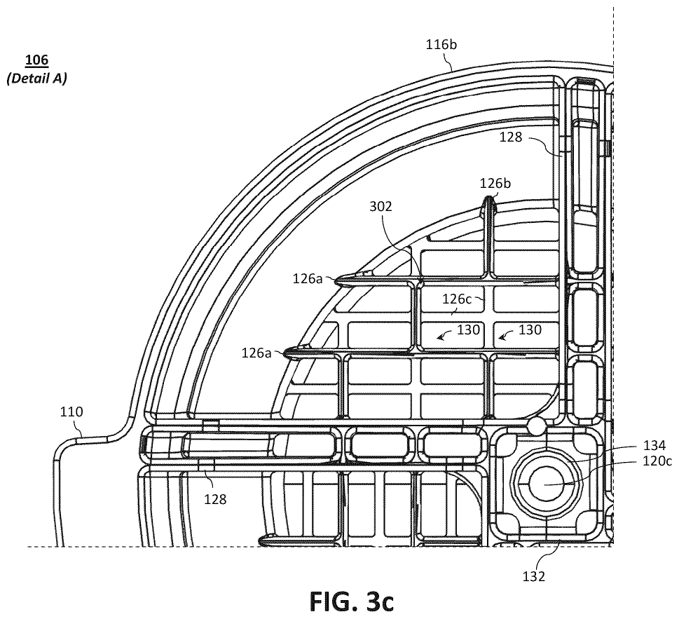

FIGS. 2a and 2b illustrate, respectively, topside and underside perspective assembled views of the example valve assembly 106. FIGS. 2c and 2d present top and bottom plan views of the example valve assembly 106. FIGS. 2e through 2h illustrate, respectively, first, second, third, and fourth side elevation views of the example valve assembly 106. FIGS. 2i and 2j show topside and underside perspective assembly views of the example valve assembly 106. FIG. 3a illustrates a perspective cross-sectional view of the example valve assembly 106 taken along cutline A-A (FIG. 2c), and FIG. 3b provides a side elevation cross-sectional view of the same. Finally, FIG. 3c illustrates a top plan view of Detail A (FIG. 2c) of the example valve assembly 106.

The valve body 116 is designed with a rigid support mesh 126 that is integrated into or positioned in its fluid passageway 138. The rigid support mesh 126 can be supported at least in part by a plurality of walls 128. The plurality of walls 128, together with the rigid support mesh 126, provides both structural support and can serve as an operator engagement component. In the illustrated example, the plurality of walls 128 are configured to offer enhanced stability of the rigid support mesh 126 within the passageway 138. Additionally, these walls 128 are configured to be gripped by an operator, allowing them to twist and rotate the valve assembly 106 relative to the component 102, thus facilitating the installation or removal of the valve assembly 106 with ease.

As illustrated, each of the plurality of walls 128 are attached to an outer perimeter (e.g., the annular portion of the second body portion 116b) and extend toward the central axis 136. In the illustrated example, the plurality of walls 128 converge about the central axis 136 and, in this case, form a central frame 132.

In the illustrated example, valve body 116 features four walls 128 within the rigid support mesh 126. These walls are arranged in a manner that effectively divides the fluid passageway 138 into four quarter-circle sections (i.e., a quadripartite design). The walls 128 not only reinforces the structural integrity of the valve body 106 but also provide convenient gripping points for the operator, making the manipulation of the valve assembly 106 straightforward and efficient. That is, the operator can manually manipulate the walls 128 via his or her hand or fingers (effectively serving as a thumb-turn feature).

As illustrated in FIGS. 2i and 2j, the interface between the valve body 116 and the annular seal 118 features a surface with a series of angular hills and valleys, creating or defining a complex topography 122. These intricate surface features result in a corresponding surface pattern 124 on the interior side of the annular seal 118 (e.g., during the manufacturing process), significantly enhancing the contact area between the annular seal 118 and the valve body 116. The increased surface area at the interface improves the attachment strength of the annular seal 118, resulting in a more secure and durable connection. This design optimization ensures the annular seal 118 maintains its integrity and functionality over an extended period, thereby improving the overall reliability of the valve assembly.

As can be appreciated, the valve body incorporates the rigid support mesh 126 and couples to the flapper 120 to permit one-way fluid flow through the valve assembly 106.

The flapper 120 is configured to permit one-way fluid flow through the passageway 138 by blocking the passageway 138 when fluid flow urges the flapper 120 against the rigid support mesh 126 and opens (i.e., vents or drains) the passageway 138 when fluid flow urges the flapper 120 away from the rigid support mesh 126.

The rigid support mesh 126 supports the flapper 120 and comprises a plurality of walls 128 that divide the passageway 138 into four quarter-circle-shapes regions. Each quarter-circle region is further divided into a grid of mesh openings 302 (illustrated as quadrilateral openings) using a first plurality of ribs 126a that are arranged transverse to a second plurality of ribs 126b. Each mesh opening 302 in this grid is further subdivided into a smaller grid of flow opening 130 using a third plurality of ribs 126c arranged to form the plurality of flow openings 130.

Therefore, the valve body 116 generally defines a passageway 138 through which fluid can flow, while the rigid support mesh 126 is position within the passageway 138. The rigid support mesh 126 is configured to provide structural support to the flapper 120 and ensure the integrity of the valve assembly 106.

In the illustrated example, the walls 128 divide the passageway 138 into regions, while the first and second plurality of ribs 126a, 126b further divide the region form a grid of mesh openings 302. The first and second plurality of ribs 126a, 126b are transverse relative to one another. Each of the mesh openings 302 is illustrated as further divided into a smaller grid using a third plurality of ribs, creating a plurality of flow openings 130.

As noted, the flapper 120 is coupled to the rigid support mesh 126 and configured to allow one-way fluid flow through the passageway 138 (via the plurality of flow openings 130). The flapper 120 flexes or otherwise moves in response to fluid pressure, opening to permit fluid flow in one direction and closing to prevent backflow.

The valve body 116 is designed to handle various fluids, including gases and liquids, ensuring reliable performance in different applications. The rigid support mesh 126 within the passageway 138 provides a robust structure for the flapper 120, enhancing the overall durability and effectiveness of the valve assembly. The design of the support mesh, with its multiple layers of ribs and flow openings, optimizes fluid flow while maintaining the necessary support for the flapper. The disclosure offers significant improvements over existing valve assemblies, providing enhanced structural integrity and reliable one-way fluid flow.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the implementations disclosed. Instead, the present method and/or system will include all implementations falling within the scope of the appended claims, both literally and under the doctrine of equivalents.

1. A valve assembly configured to control fluid flow through a component opening in a component, the valve assembly comprising:
a valve body having a passageway through which fluid can flow;
a rigid support mesh located within the passageway, the rigid support mesh including
one or more walls configured to divide the passageway into two or more sub-regions, and
a first plurality of ribs arranged transverse to a second plurality of ribs and configured to form a grid of mesh openings within each quarter-circle region; and
a flapper coupled to the rigid support mesh and configured to permit one-way fluid flow through the passageway,
wherein the valve assembly is configured to removably couple with the component via the component opening.

2. The valve body of claim 1, further comprising a third plurality of ribs arranged to further divide each mesh opening into a smaller grid having a plurality of flow openings.

3. The valve body of claim 2, wherein a cross-sectional area of each of the third plurality of ribs is smaller than a cross-sectional area of each of the first and second plurality of ribs.

4. The valve body of claim 1, wherein the flapper is configured to open in response to fluid pressure in one direction and to close to prevent backflow.

5. The valve body of claim 1, wherein the rigid support mesh provides structural support to the flapper to maintain its position and functionality.

6. The valve body of claim 1, further comprising an annular seal configured to form a seal between the valve body and the opening.

7. The valve body of claim 6, wherein the valve body comprises a complex topography and the annular seal is coupled to the valve body at the complex topography.

8. The valve body of claim 1, wherein the valve body and the rigid support mesh are a unitary component.

9. The valve body of claim 1, wherein the valve body is a rigid component.

10. The valve body of claim 9, wherein the flapper is a flexible component.

11. The valve body of claim 1, wherein the flapper is coupled to the rigid support mesh via a pin receiver.

12. The valve body of claim 11, wherein the flapper comprises a conical body having a rim at its outer perimeter and an attachment pin at its center.

13. The valve body of claim 12, wherein the attachment pin is aligned with the central axis.

14. The valve body of claim 1, wherein the valve body comprises a plurality of component-locking tabs, each of the plurality of component-locking tabs is configured to engage the component opening via a receiver in one of an unlocked or a locked position.

15. The valve body of claim 14, wherein the valve body comprises a plurality of component-attachment features, each of the plurality of component-attachment features is configured to engage the component on a side opposite the receiver.

16. A valve assembly configured to control fluid flow through a component opening in a component, the valve assembly comprising:
a valve body having a passageway through which fluid can flow;
a rigid support mesh located within the passageway, the rigid support mesh including
one or more walls configured to divide the passageway into two or more sub-regions, and
a first plurality of ribs arranged transverse to a second plurality of ribs and configured to form a grid of mesh openings within each quarter-circle region; and
a flapper coupled to the rigid support mesh and configured to permit one-way fluid flow through the passageway,
wherein the flapper is configured to open in response to fluid pressure in one direction and to close to prevent backflow, and
wherein the valve assembly is configured to removably couple with the component via the component opening.

17. The valve body of claim 16, wherein the rigid support mesh provides structural support to the flapper to maintain its position and functionality.

18. The valve body of claim 16, further comprising an annular seal configured to form a seal between the valve body and the opening.

19. The valve body of claim 1, wherein the flapper is coupled to the rigid support mesh via a pin receiver.

20. A valve assembly configured to control fluid flow through a component opening in a component, the valve assembly comprising:
a valve body having a passageway through which fluid can flow, wherein the valve body comprises a plurality of component-locking tabs, each of the plurality of component-locking tabs is configured to engage the component opening via a receiver in one of an unlocked or a locked position;
a rigid support mesh located within the passageway, the rigid support mesh including
one or more walls configured to divide the passageway into two or more sub-regions, and
a first plurality of ribs arranged transverse to a second plurality of ribs and configured to form a grid of mesh openings within each quarter-circle region;
a flapper coupled to the rigid support mesh and configured to permit one-way fluid flow through the passageway,
wherein the flapper is configured to open in response to fluid pressure in one direction and to close to prevent backflow, and
wherein the valve assembly is configured to removably couple with the component via the component opening; and
an annular seal configured to form a seal between the valve body and the component opening.
